(19) United States
(12) Patent Application Publication
(10) Pub. No.: US 2004/0095847 A1
(43) Pub. Date: May 20, 2004

(54) Acoustic devices to measure ultrasound velocity in drilling mud

(75) Inventors: Gamal A. Hassan, Houston, TX (US); Eric Brian Molz, Houston, TX (US); Philip L. Kurkoski, Houston, TX (US)

Correspondence Address: PAUL S MADAN, MADAN, MOSSMAN & SRIRAM, PC, 2603 AUGUSTA, SUITE 700, HOUSTON, TX, 77057-1130, US

(73) Assignee: Baker Hughes Incorporated

(21) Appl. No.: 10/298,706

(22) Filed: Nov. 18, 2002

(51) Int. Cl. G01V 1/00

(52) U.S. Cl. 367/25

(57) ABSTRACT

An apparatus and method is disclosed for measuring ultrasound drilling mud velocity downhole in real time. One or more generated acoustical pulses are detected upon traversing two separate path lengths, and ultrasonic velocity is determined from differences in the pulses upon traversing their respective path lengths. Alternately, a single measurement can be made using an acoustic pulse traversing a specified path length. A transducer is discussed having a piezoelectric crystal, a backing material having matching impedance, and a facing material disposed between the crystal and the fluid having an impedance intermediate to crystal and fluid. A concave front face of the crystal increases sensitivity to off-axis signals. Improved signal resolution can be achieved using a controlled shape input pulse optimized for certain drilling conditions. A method of echo detection using wavelet analysis is preferred.

### BACKGROUND OF THE INVENTION

1. Field of the Invention

The invention relates to the field of acoustic measurement devices in oil exploration. Specifically, the invention is a method of measuring ultrasound velocity in drilling mud in a borehole formation.

2. Background of the Art

Ultrasonic pulse-echo measurements have long been used in wireline and LWD tools to measure a variety of parameters including instantaneous standoff, borehole caliper, or features on the borehole wall such as rugosity, fractures, or cracks. Basic ultrasonic properties are described, for instance, in “Ultrasonic Properties of Oil-Well Drilling Muds”, Hayman, Ultrasonics Symposium, IEEE, 1989. Standoff measurements have been described, for instance, in “Standoff and Caliper Measurements While Drilling Using a New Formation-Evaluation Tool with Three Ultrasonic Transducers, Birchak et al., SPE 68^{th} Annual Technical Conference, 1993, “MWD Ultrasonic Caliper Advanced Detection Techniques”, Althoff et al., SPWLA 39^{th} Annual Logging Symposium, 1998, and “Utilizing Acoustic Standoff Measurements to Improve the Accuracy of Density and Neutron Measurements”, Minette et al., SPE Annual Technical Conference, 1999. Examples of imaging uses of ultrasound can be found in “High-Resolution Cementation and Corrosion Imaging by Ultrasound”, Hayman et al., SPWLA 32^{nd} Annual Logging Symposium, 1991, attenuation measurements are described, for instance, in “Ultrasonic Velocity and Attenuation Measurements in High Density Drilling Muds”, Molz et al., SPWLA, 39^{th} Annual Logging Symposium, 1998.

The working principle for all of these downhole applications involves mounting one or more highly mechanically damped ultrasonic transducers on a logging-while-drilling (LWD) tool for use during a drilling operation. The transducer emits a short duration broadband pulse. The pulse then reflects from the surface being probed and returns and re-excites the emitting transducer. The transducer is positioned such that at least some of the acoustic pulse propagates through the surrounding man-made borehole fluid, commonly referred to as drilling mud.

Inaccuracy in the exact value of ultrasound velocity in the borehole fluids limits the accuracy of the measurement. The transit time τ for the echo determines the distance D to the reflecting surface. D=V_{mud}*τ. However, the accuracy of the conversion from transit time to distance traveled is limited by the accuracy of the value of ultrasound velocity in the drilling mud, V_{mud}. The ultrasound velocity in standard drilling mud is usually within 20% of that of water (1493 m/sec). Thus the propagation distance may have 20% inaccuracy. Higher accuracy is often required.

Wireline tools have been developed which compensate for velocity-variation effects. This parameter is measured in real-time to facilitate correcting borehole imaging and for casing inspection. The working principle behind these tools requires a piezoelectric transducer mounted into the wall of a hollow chamber in the wireline tool such that the transducer faces a wall on the opposite side of the chamber. The chamber itself fills with fluid while downhole. The ultrasonic energy travels through the drilling fluid, reflects from the opposite wall, returns and re-excites the transducer. The ultrasonic velocity is determinable once the operator knows the delay time and the travel distance. Ultrasound attenuation can also be measured. Such an apparatus cannot be adapted to an LWD tool, where tighter size and strength constraints exist. Further, continuously flowing cuttings fills the chamber and produces either erroneous ultrasound velocity or, due to scattering of the ultrasound wave, no ultrasound velocity at all.

LWD tools, like drilling pipe itself, are cylindrical, hollow, and threaded on each end to mount with pipe or other LWD tools in order to form a bottom hole assembly (BHA). The outer diameter of the LWD tool is less than that of the drilling bit. Drilling fluid or mud is circulated from the surface, through the center of the drilling pipe and BHA, out the bit, and returns to the surface between the outer diameter of the pipe and BHA and the borehole wall. The LWD tool, along with the rest of the BHA, may be rotated during drilling or held stationary, while the sliding bit rotates. The ultrasonic transducers are mounted on the outer diameter of the LWD facing the borehole wall to measure the borehole size (caliper) or the instantaneous distance from a point on the outer diameter of the tool to the borehole wall (standoff). Such measurements can be made by a stand-alone tool or can be used in conjunction with other measurements, such as nuclear density or porosity.

Any drilling mud is mixed to have unique properties and thus each drilling mud has a unique ultrasound velocity. The velocity in the mud is determined by such factors as the mud type (oil or water), the mud weight, density, temperature, pressure, the amount of cuttings in the mud, the amount of formation fluids entering the mud, etc. As if this were not enough, the ultrasound speed in mud can change at any time as the well advances due to changing mud weight for borehole stability or a change in drilling conditions. Thus, while an improvement, calculating the mud velocity a priori and applying a correction factor has limited accuracy, as is described in “Mud Velocity Corrections for High Accuracy Standoff/Caliper Measurements” Molz, SPWLA 41^{st} Annual Logging symposium, 2001. What is needed is a method for measuring ultrasound velocity in the mud downhole while the drilling continues. The measured mud velocity can then be used to correct caliper and standoff values in real time.

U.S. Pat. No. 4,571,693 issued to Birchak et al discloses a method for measuring ultrasonic mud properties in a drilling environment. The method of Birchak '693 involves using one or more ultrasonic transducers mounted within the body of a metal probe. The probe has a cavity cut from it with sides perpendicular to the direction of the ultrasonic wave. The probe connects to the LWD tool such that the cavity fills with drilling fluid when downhole. The ultrasonic signal propagates through the metal body, across the metal/mud interface, into the drilling fluid, reflects from the second mud/metal interface and back. Fluid properties are determined from the amplitude and the travel time of the return signal. Three problems exist with design described in Birchak '693. First, with all the interfaces present in the invention, multiple echoes are observed. Secondly, the mud velocity is not the only variable ultrasound velocity involved. The ultrasound velocity of the metal changes with temperature, too. Third, the design of Birchak '693 is difficult to mount on a typical LWD tool, where size is often a major constraint.

The invention herein discloses methods to measure ultrasound velocity and attenuation in drilling mud in an LWD environment. The device is particularly useful in applications where real-time mud velocity corrections are needed and cannot be applied after LWD tool use.

### SUMMARY OF THE INVENTION

The invention is an apparatus and method for measuring ultrasonic velocity in a fluid within a borehole. The apparatus comprises an acoustic transmitter for generating acoustic waves in the fluid, a first receiver and a second receiver for detecting acoustic waves propagated through the fluid over two separate path lengths, and a processor for determining the parameter of interest from the first and second travel times of the acoustic waves over the respective path lengths. The parameter of interest can comprise the velocity of the acoustic waves in the fluid or a value for the standoff of the logging tool from the wall of the borehole. The processor controls the activation of the transmitter. In one embodiment of the invention, one of the acoustic transmitters is set in a recess on the logging tool, and the difference between the first and second path lengths is equal to the depth of the recess. Typically, in this embodiment, the two transmitters are at the same longitudinal position and separated by a toolface angle. This embodiment of the invention is enabled through rotation of the tool through the toolface angle. An orientation sensor obtains a measurement of the toolface angle. Such an orientation sensor can comprise a magnetometer, for instance.

In another embodiment of the invention, the first and second receivers are spaced apart along the longitudinal direction of the logging tool. Optionally, one of the receivers can be set in a recess of the logging tool. The acoustic transmitter and either the first or second receiver comprise a single transducer.

In yet another embodiment of the invention, an acoustic transmitter and acoustic receiver are positioned so as to measure an acoustic wave upon propagation over a specified path length. A typical instance of the embodiment would have the acoustic transmitter and acoustic receiver disposed along opposing walls of a recess in the logging tool, the specified path length being the distance between the acoustic transmitter and the acoustic receiver. In another instance of the embodiment, the acoustic transmitter and the acoustic receiver would comprise a single transducer disposed along a one of the opposing walls of the recess in the logging tool. The specified path length would comprise twice the distance from the transducer to the opposing wall.

A transducer used in the invention comprises a piezoelectric crystal, a backing material having an impedance substantially matching that of the crystal, and a facing material disposed between the crystal and the fluid having an impedance intermediate to that of the crystal and that of the fluid. A typical backing material can be composed of a tungsten-polymer mixture. A typical facing material can be composed of Torlon. The front face of the piezoelectric crystal is typically concave to increase sensitivity to signals approaching from off-axis.

A method of the invention comprises generating at least one acoustical pulse, obtaining a first measurement of a physical quantity of the at least one pulse propagated over a first path length, obtaining a second measurement of same physical quantity of the at least one pulse propagated over a second path length, and determining a parameter of interest from the differences in said measurements. The method enables measurement of physical quantities from two receivers having a path length difference equal to the recess difference, as in the embodiment with two receivers displaced by a toolface angle. Also, the method enables measurement of physical quantities from the embodiment having two receivers displaced by a longitudinal distance along the tool.

In another method of the invention, a transmitter generates an acoustical pulse and a receiver measures the acoustical pulse after it has traveled a specified distance. The parameter of interest can be determined by the measurements and knowledge of the length of the specified distance.

Improved signal resolution can be achieved using a controlled shape input pulse. Such a controlled pulse can be optimized for certain drilling conditions. A method of echo detection using wavelet analysis is preferred, thereby improving the dynamic range of detection for ultrasonic pulse echoes.

### BRIEF DESCRIPTION OF THE DRAWINGS

FIG. 1A (prior art) is a simplified depiction of a drilling rig, a drillstring and a wellbore equipped with an apparatus for interrogating the borehole in accordance with the present invention.

FIG. 1B shows an azimuthal cross section of a method of the invention.

FIG. 2 shows the peripheral electronics required to obtain a measurement using the method depicted in FIG. 1.

FIGS. 3a, 3b show a longitudinal cross-sections of a second method of the invention.

FIG. 4 shows the peripheral electronics required to obtain a measurement using the embodiment depicted in FIGS. 3a and 3b.

FIG. 5 is an azimuthal cross-section of a third method of the invention.

FIG. 6 shows the peripheral electronics required to obtain a measurement using the method depicted in FIG. 5.

FIG. 7 is the design of an LWD ultrasonic transducer that makes high-resolution pulse-echo measurements.

FIG. 8 is a graph showing the effect of changing frequency and duration of a sine wave high voltage input on the shape of the transducer emitted pulse.

### DESCRIPTION OF THE PREFERRED EMBODIMENT

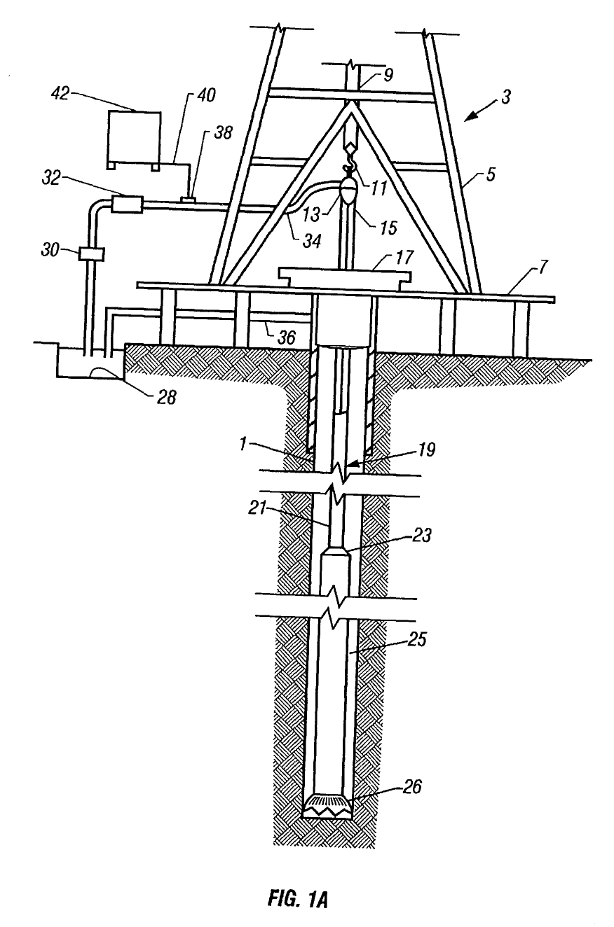

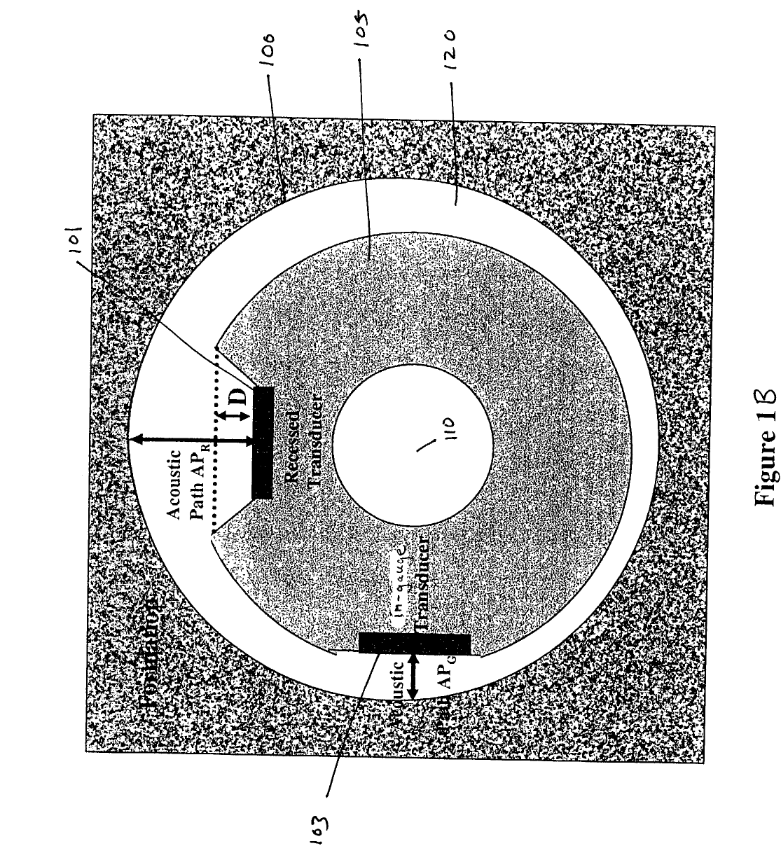

With reference to FIG. 1A, there will now be described an overall simultaneous drilling and logging system in accordance with one preferred embodiment of the present invention that incorporates an electromagnetic wave propagation (EWP) resistivity measurement system according to this invention.

A well 1 is drilled into the earth under control of surface equipment including a rotary drilling rig 3. In accordance with a conventional arrangement, rig 3 comprises a derrick 5, derrick floor 7, draw works 9, hook 11, swivel 13, kelly joint 15, rotary table 17, and drill string 19 that comprises drill pipe 21 secured to the lower end of kelly joint 15 and to the upper end of a section of drill collars including an upper drill collar 23, an intermediate drill collar or sub (not separately shown), and a lower drill collar measurement tubular 25 immediately below the intermediate sub. A drill bit 26 is carried by the lower end of measurement tubular 25.

Drilling fluid (or “mud”, as it is commonly called) is circulated from a mud pit 28 through a mud pump 30, past a desurger 32, through a mud supply line 34, and into swivel 13. The drilling mud flows down through the kelly joint and an axial tubular conduit in the drill string, and through jets (not shown) in the lower face of the drill bit. The drilling mud flows back up through the annular space between the outer surface of the drill string and the inner surface of the borehole to be circulated to the surface where it is returned to the mud pit through a mud return line 36. A shaker screen (not shown) separates formation cuttings from the drilling mud before it returns to the mud pit.

The overall system of FIG. 1A uses mud pulse telemetry techniques to communicate data from downhole to the surface while drilling operation takes place. To receive data at the surface, there is a transducer 38 in mud supply line 34. This transducer generates electrical signals in response to drilling mud pressure variations, and these electrical signals are transmitted by a surface conductor 40 to a surface electronic processing system 42.

FIG. 1B shows a method of the invention comprised of two transducers displaced by a toolface angle along a tool device 105. The tool device 105 could be positioned, for example, at the drill collar measurement tubular 25 of FIG. 1A. The transducers measure an ultrasound velocity and attenuation of a signal transmitted into a drilling mud 120. The position of the first transducer 101, referred to herein as the recessed transducer, is recessed a distance D closer to the center axis 110 of said drilling tool 105 than the second transducer 103, hereafter referred to as the in-gauge transducer. The recess distance D is chosen to be large enough to give an accurate value of mud velocity. Both transducers are mounted at the same vertical position along the axis of the tool. The front faces of both transducers face the borehole wall 100 such that the acoustic paths of the emitted ultrasonic pulses extend toward the borehole wall and back to the transducer face.

A first signal is produced at the in-gauge transducer, which also records the echo and attenuation of the first signal. Then the tool is rotated by rotation of the drillstring so that the recessed transducer is in substantially the same position at which the in-gauge transducer obtained measurements of the first signal. Measurement of toolface rotation can be made by magnetometers (not shown), for example. The recessed transducer then produces a second signal, and records echo and attenuation of the second signal.

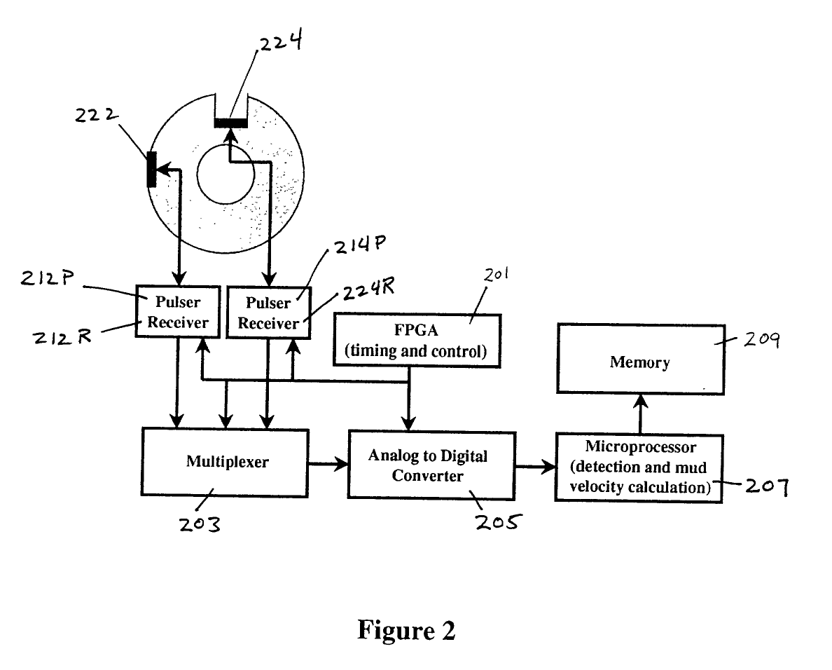

FIG. 2 shows a typical electronics assembly that enables measurement of the transit time for the echoes reflected from the borehole wall. This is shown with reference to the device of FIG. 1B. System timing is controlled by an Field Programmable Gate Array (FPGA) 201, which sends a signal to the transducer pulsers. To obtain a measurement at the in-gauge transducer 222, the pulser 212P fires the in-gauge transducer at a time set by the FPGA 201. The echo signal is received by the receiver 212R and sent to a multiplexer 203. The multiplexer 203 is set to channel corresponding to the receiver 212R of the in-gauge transducer.

The signal is then sent from through the multiplexer 203 to an analog to digital converter 205. Upon receiving said signal, the analog to digital converter 205 immediately starts digitizing data. The digitized data is placed in memory 209. The data in memory is processed by the microprocessor 207 to determine the transit time between firing and echo return and to determine the amplitude of the received echo. The described process is repeated for the recessed transducer 224, with signals produced by the transducer pulser 214P and received by the transducer receiver 214R.

As the tool device 105 rotates, every point on the outer tool diameter eventually passes through the same toolface angle. Toolface angle can be related to azimuthal angle using methods disclosed, for instance, in U.S. Pat. No. 4,909,336, issued to Brown et al. Thus, the recessed transducer 101 eventually passes through the same points as the in-gauge transducer 103. When the tool is rotated so that the recessed transducer faces the same toolface angle at which a measurement of the in-gauge transducer has been obtained, said recessed transducer sees the same acoustic path of the in-gauge transducer lengthened according to the recessed distance D. For firings correlated to the toolface angle, the transit time before echo detection recorded by the recessed transducer, τ_{R}, will be greater than the correlated transit time recorded by the in-gauge transducer τ_{G} at the same toolface angle within the borehole. The ultrasound velocity of the mud can then be calculated via

V_{mud}=D/2(τ_{R}−τ_{G}) (2)

In addition, the amplitude of the echoes for the recessed transducer, A_{R}, and for the in-gauge transducer, A_{G}, can be measured, and the attenuation of the signal due to the mud, α_{mud}, can be calculated via

α_{mud}=20*log[A_{R}/A_{G}]/D (3)

A system of logic correlates the toolface angle of each transducer. Since LWD tools can move laterally within the borehole as well as circumferentially, the recessed transducer may be shifted to a different location along the axial length by the time it has rotated into the toolface angle position at which the in-gauge transducer has recorded its measurements. Therefore, each transducer may measure different positions along the borehole wall and thus different standoffs at the same toolface angle orientation. Furthermore, upon a complete rotation of the tool device, the caliper value of any one transducer may be slightly different from that of another. There are simple solutions to this problem. There is a minimum standoff that a transducer can be from the borehole wall. This minimum standoff corresponds to a minimum transit time. The standoff transit time measured by the system never goes below this minimum velocity besides the obvious mud velocity uncertainty. Since tool rotation is at least 60 RPM and often as high as 180 RPM, the minimum transit time will be encountered, if not in the first rotation due to lateral movement, then quickly on subsequent rotations. The minimum transit times over a period of rotations can be used in equations 2 and 3 for mud velocity and attenuation. Other coherent features of the standoff during tool rotations, such as washouts, can also be used.

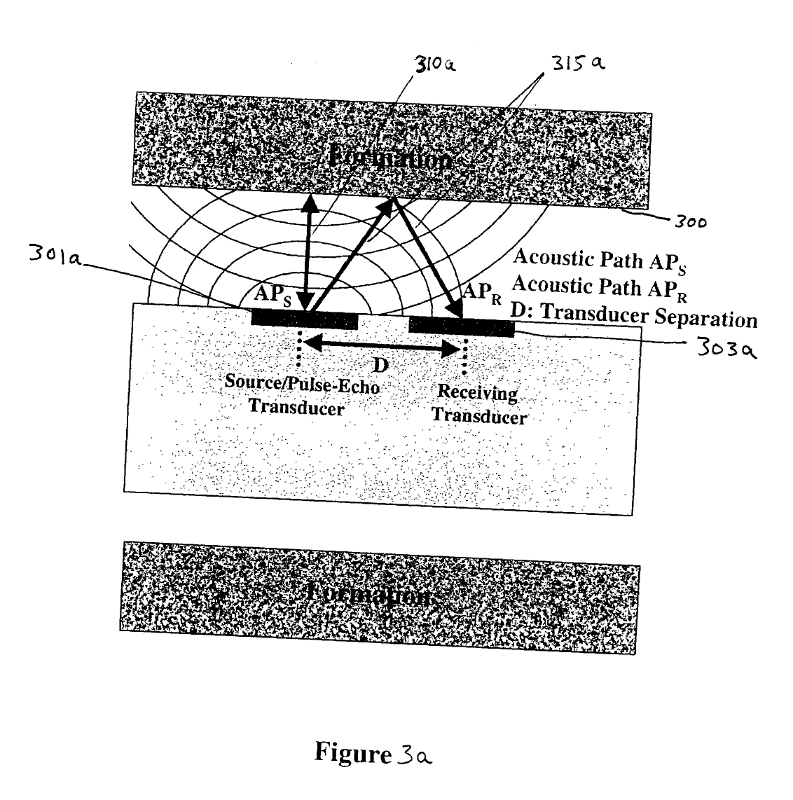

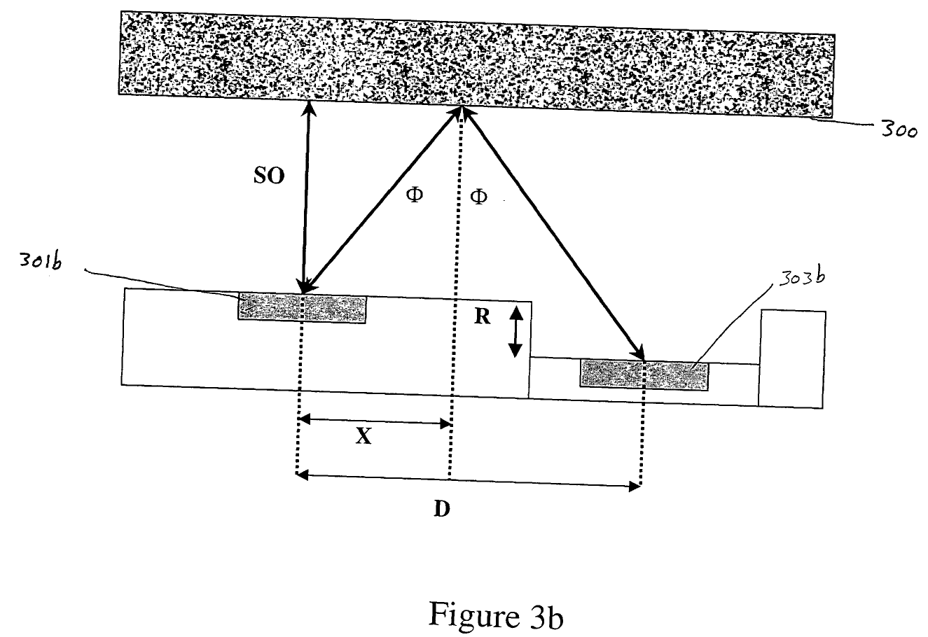

FIGS. 3a and 3b show a second method of the invention comprised of two transducers displaced axially along a tool device. In the second method shown in FIG. 3a, the position of one transducer, hereafter referred to as the source transducer 301a, is separated by a distance D in the axial direction from a second transducer, hereafter referred to as the receiving transducer 303a. The transducers are mounted at the same toolface angle on the tool. The separation D between transducers 301a and 303a must be large enough to provide an accurate value of ultrasound velocity in the drilling mud. The front faces of both transducers are substantially facing the borehole wall 300. The source transducer 301a can be used in a normal pulse-echo mode. The receiving transducer 303a, rather than being fired, receives the echo caused by firing the source transducer 301a. Alternately, the method would work equally well having transducer 301a and 303a both transmitting a pulse, while one transducer, for example, 301a, can be used to detect the acoustic waves generated by both 301a and 303a. The acoustic paths of the source AP_{S} 310a and of the receiver AP_{R} 315a created in such an embodiment are shown in FIG. 3a. The acoustic path for the source transducer AP_{S} 310a is simply the distance from the center face of source transducer 301a to the borehole wall 300 and back to the source transducer 301a. The acoustic path of the receiver transducer AP_{R} 315a is the distance from the center face of the source transducer 301a to a point on the borehole wall 300 half way between the two transducers back to the center face of the receiver transducer 303a.

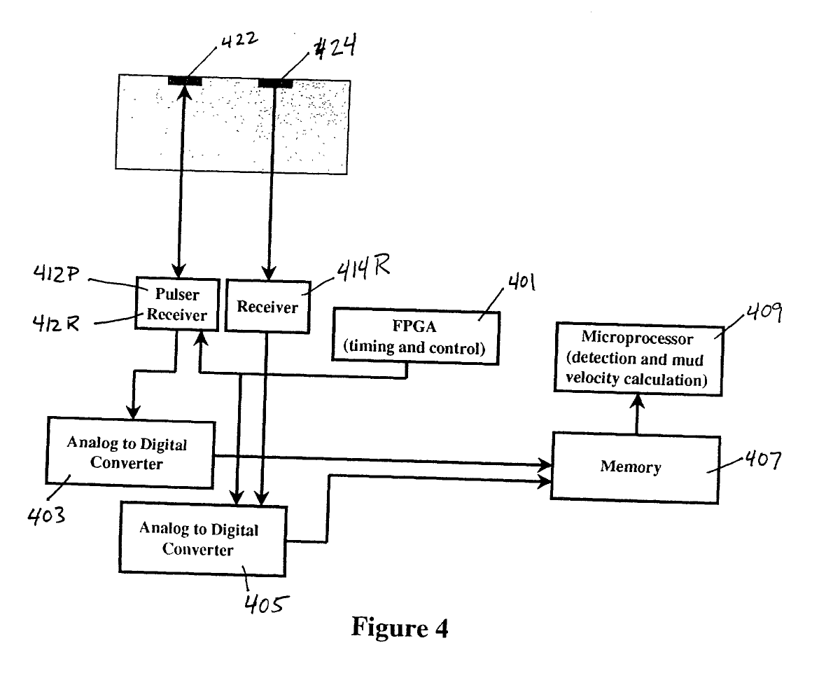

FIG. 4 shows a typical electronics assembly that measures the transit time for the echoes traveling the acoustic paths of FIG. 3a or of FIG. 3b. System timing is controlled by an FPGA 401. The pulser 412P fires the source transducer 422 at a time set by the FPGA 401. The return signal received by the source transducer 422 is sent from the receiver electronics 412R to an analog to digital converter 403. The digitized data is placed in memory 407. Simultaneously, the signal from the receiving transducer 424 is sent from the receiver electronics 414R to another analog to digital converter 405. The digitized data is placed in memory 407. The data in memory is processed by the microprocessor 409 to determine the delay after firing and the amplitude of the echo for the source transducer 422 and for the receiving transducer 424.

In FIG. 3a, since AP_{R} 310a is larger than AP_{S} 315a, the transit time for the echo received at the receiver transducer (τ_{R}) will be longer than the transit time for the echo received at the source transducer (τ_{S}). The mud velocity can be calculated using these two transit times and the value of the separation D. The two acoustic paths are related through a right triangle:

AP_{R}²=AP_{S}²+(D/2)² (4)

Replacing path lengths with measured transit times and the unknown mud velocity yields:

(τ_{R}*V_{mud})²=(τ_{S}*V_{mud})²⁺(D/2) (5)

Solving for mud velocity yields a function of transit times and separation D:

V_{mud}=D/[2(τ_{R}²−τ_{S}²)^{1/2}] (6)

In addition, the amplitude of the two echoes, A_{R} and A_{S}, can be measured, and the attenuation, α_{mud}, can be calculated via

α_{mud}=20*log[A_{R}/A_{S}]/D (7)

In an alternate technique of the second method, the receiver transducer can be recessed into the tool device, as shown in FIG. 3b. Mud velocities are solved through similar methods. The acoustic path for the echo at the source transducer 301b is given by AP1=V_{mud}T₁=2SO, where SO is the perpendicular distance from the source transducer to the borehole wall 300. This equation can be solved for SO to yield the equation:

$$SO = \frac{{V}_{mud} * {T}_{1}}{2} . \qquad ( 8 )$$

The acoustic path for the echo at the receiver transducer 303b is given by

AP2=V_{mud}T₂=(SO²+X²)^{1/2}+{(SO²+R²)^{1/2}+(D−X)²}^{1/2} (9)

where D is the distance from source transducer to receiver transducer, X is the distance along the axis from the source of the pulse to its point of reflection, and R is the depth of recession of the receiver transducer. Since angle of incidence Φ equals the angle of reflection, the following two equalities can be set up:

$$tan Φ = \frac{SO}{X} = \frac{SO + R}{D - X} \qquad ( 10 )$$

to obtain

$$X = \frac{SO * D}{2 SO + R} \cdot \qquad ( 11 )$$

Equation 8 can be substituted into equation 11 to get

$$X = \frac{( \frac{{V}_{mud} * {T}_{1}}{2} ) * D}{{V}_{mud} * {T}_{1} + R} \qquad ( 12 )$$

Finally, the following relation can be formed by substitution of eqations 8 and 12 into equation 9:

$$\begin{matrix}{V}_{mud} * {T}_{2} = {( {( \frac{{V}_{mud} * {T}_{1}}{2} )}^{2} + {( \frac{( \frac{{V}_{mud} * {T}_{1}}{2} ) * D}{{V}_{mud} * {T}_{1} + R} )}^{2} )}^{1 / 2} + \\ {\{ {( \frac{{V}_{mud} * {T}_{1}}{2} + R )}^{2} + {( D - ( \frac{( \frac{{V}_{mud} * {T}_{1}}{2} ) * D}{{V}_{mud} * {T}_{1} + R} ) )}^{2} \}}^{1 / 2} .\end{matrix} \qquad ( 13 )$$

Equation 13 can be solved to obtain mud velocity.

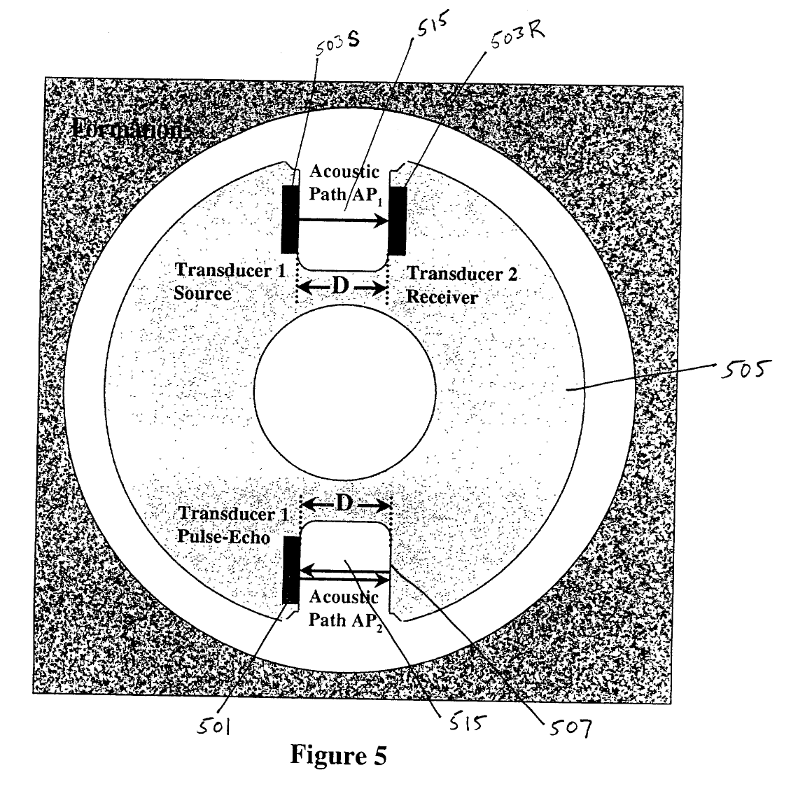

FIG. 5 shows two possible techniques of a third method of the invention. A pulse-echo technique is displayed at the bottom of FIG. 5 and a source-receiver technique is displayed at the top. Unlike the first two methods of the invention, neither technique of this method uses the borehole wall as the reflecting surface. Rather, the ultrasonic signal can reflect off of the body of the LWD tool 505. For the pulse-echo technique (shown at bottom), a channel 515 of tightly controlled width is machined into the body of the LWD tool 505 or into a module that fits into the LWD tool 505. A transducer 501 is mounted into one side of the channel so that the front face is pointed toward the opposite wall 507. During drilling, this channel fills with drilling mud. The acoustic path (AP₂) for the pulse-echo technique uses a two-way travel path. An ultrasonic pulse is emitted into the channel 515, reflects from the face of the opposite wall 507, returns, and re-excites the transducer 501 after a delay time τ₂. The velocity of ultrasound in the mud can be calculated using this measured delay time.

For the source-receiver technique (shown at top), a second transducer is mounted in the wall opposite the first transducer. The acoustic path (AP₁) uses a one-way travel path. An ultrasonic pulse is emitted from the source transducer 503S, travels through the channel 515, and excites the receiver transducer 503R after some delay time τ₁. The velocity of ultrasound in the mud can be calculated from this delay time.

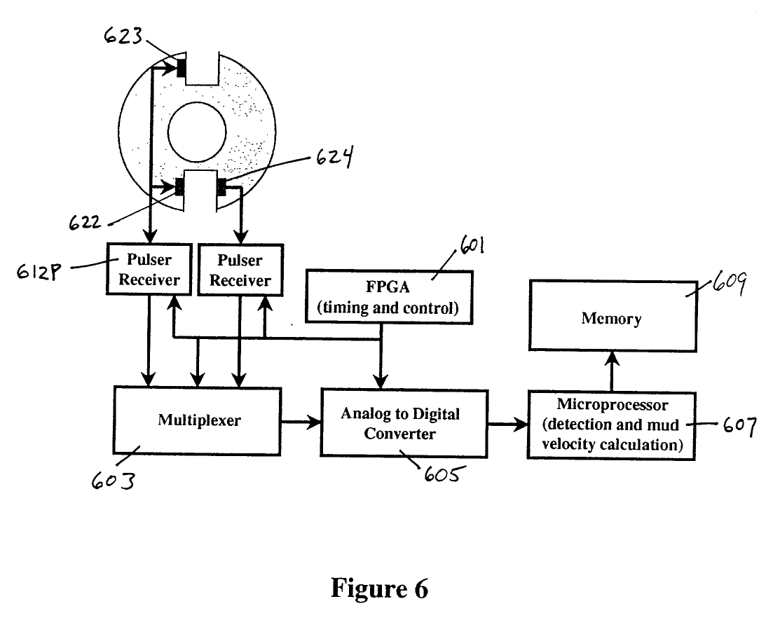

FIG. 6 shows a typical electronics assembly for measuring the transit times for the echoes traveling the acoustic paths of FIG. 5. System timing is controlled by an FPGA 601. The pulser 612P fires either the pulse-echo transducer 623 of pulse-echo technique or the source transducer 622 of the source-receiver technique at a time set by the FPGA 601. The returned echo signal is received either by the pulse-echo transducer 623 of the pulse-echo technique or by the receiver transducer 624 of the source-receiver technique. Data is sent to the multiplexer 603, which sends data to the analog to digital converter 605. The digitized data is placed in memory 609. The data in memory is processed by the microprocessor 607 to determine the delay after firing and amplitude of the echoes for the pulse-echo transducer and for the receiving transducer.

In both techniques discussed with reference to FIG. 5, only one delay time is measured. Therefore delay times in water, τ_{1W} and τ_{2W}, are used to calibrate against for both techniques. The ultrasound velocity in standard drilling mud is usually within 20% of that of water. The value of ultrasound velocity in drilling mud is found in the literature, for example, in “The Operation Characteristics of a 250 KHz Focused Borehole Imagine Device”, Zemanek et al., SPWLA 31^{st} Annual Logging Symposium, 1990, and “New Ultrasonic Caliper for MWD Applications”, Orbin et al., SPE Drilling conference, 1991. A typical value for this velocity is 1493 m/sec. Once these delay times are measured, the ultrasound velocity in drilling mud can thus be calculated:

(pulse-echo) V_{mud}=1493 m/sec*(τ₁/τ_{1W}) (13)

(source-receiver) V_{mud}=1493 m/sec*(τ₂/τ_{2W}) (14).

Also, in both techniques of this method, only one amplitude is measured. Therefore previously obtained values for the amplitudes in water, A_{1W} and A_{2W}, are used to calibrate against for both techniques. Once these amplitudes are obtained, the ultrasound attenuation in drilling mud can be calculated:

(pulse-echo) α_{mud}=20*log[A₁/A_{1W}]/2D (15)

(source-receiver) α_{mud}=20*log[A₂/A_{2W}]/2D (16).

It should be noted that either transducer can be used as the source or the receiver in the source-receiver method. Further, since the ultrasonic wave reflects from the front face of a transducer almost as well as from metal, the transducers in the source-receiver technique can be used in a pulse-echo mode.

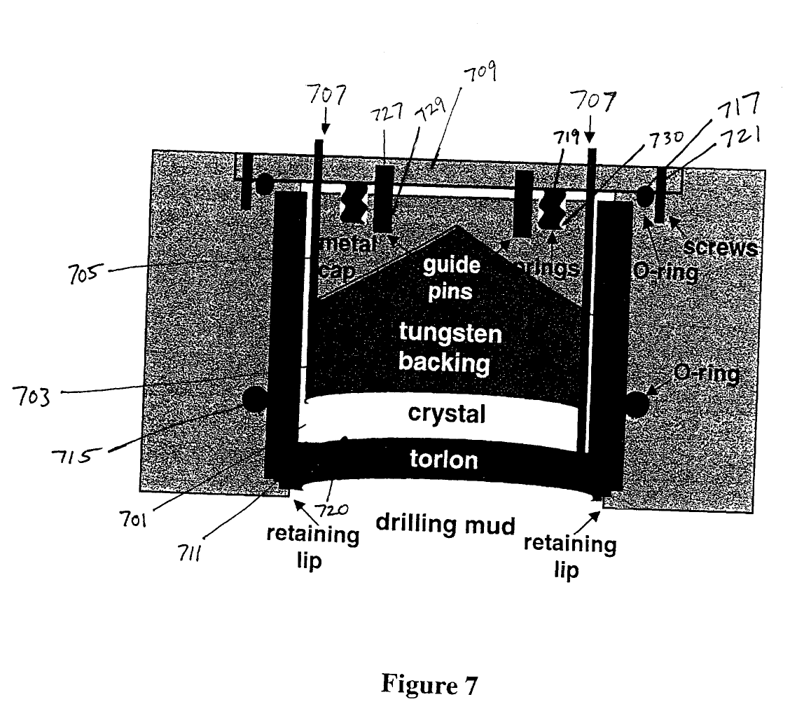

FIG. 7 shows an embodiment of a high-resolution pulse-echo broadband transducer designed for LWD applications including standoff and caliper determination. The design comprises a piezoelectric crystal 701 backed with a heavy tungsten-polymer mixture 703. The backing material 703 is bonded into a metal cap 705 to give the back a flat, uniform surface. The crystal 701 is machined concave. Leads 707 are soldered to the front and back electrodes prior to applying the backing material. This crystal/backing/metal cap combination fits into a Torlon housing piece 711 with the crystal 701 in contact with the front Torlon face 720. The Torlon housing 711 is machined with sides thick enough to withstand the wear of the drilling environment. The inner and outer faces of the Torlon front 720 are machined to the same curvature of that of crystal 701. The Torlon housing 711 fits either into a window machined either into an independent module that fits into an LWD tool or into the LWD tool itself so that the front face 720 is exposed to the drilling mud. The module or tool has a groove and O-ring 715 to seal the drilling mud from the inside of the transducer. A backing plate 709 (for the module design), O-ring 717, and screws 721, seal the back of the transducer. The backing plate 709 also performs two other functions. While mounting the back plate, a spring 719 is compressed between a groove 730 in the metal cap 705 and the backing plate 709. The backing plate 709 acts as the resistance for the spring loading of the piezoelectric crystal 701 to the Torlon housing front face 720. The backing plate 709 comprises guide pins 727 that fit into holes 729 in the metal cap 705. The backing plate 709 acts to keep the crystal/backing/metal cap combination from moving or rotating. The module or tool is machined with retaining lips to fasten the housing while spring loading. The transducer is filled with oil for pressure compensation. Not shown in FIG. 7 are a fill port and a method for oil-pressure compensation.

Impedance matching enables acoustic energy to leave the crystal through both the front and back faces, further enabling a high-resolution transducer to be heavily damped with minimal ringing after firing. Impedance matching for the front and back faces is done with very different methods. The tungsten-polymer backing material 703 is designed to be very dense and hard, yielding a high acoustic impedance close to that of the crystal 701. Much of the acoustic energy leaves the crystal 701 and enters the backing 703. The backing material is also designed with high acoustic attenuation. With high acoustic attenuation, the energy that leaves and is reflected from edges of the crystal and external drilling mud cannot re-excite the crystal. This, along with a carefully designed thickness, maximizes the energy that leaves the crystal and enters the drilling mud. The crystal is machined with curvature, enabling higher sensitivity to ultrasonic energy that is approaching the transducer off the axis perpendicular to the Torlon front face 720. The internals of the transducer are oil-filled to enable acoustic coupling, and to displace any air gap between the crystal and Torlon that might ruin the acoustic coupling. These oil-filled internals also enable oil pressure compensation between the drilling mud and the internal transducer. Spring loading ensures excellent contact between the crystal and the Torlon.

A methodology of exciting and detecting a high-resolution pulse is presented here. The transducers used to generate these high-resolution pulses are highly mechanically damped and have a broadband response around their fundamental frequency. In general, these transducers are excited electrically with a high voltage spike having a wide range of frequency components. Given this broadband input, the transducer “picks” its fundamental frequency, as well as significant components surrounding the fundamental, as the frequency to transmit. The signature of the transmitted pulse with this type of input excitation is very difficult to control.

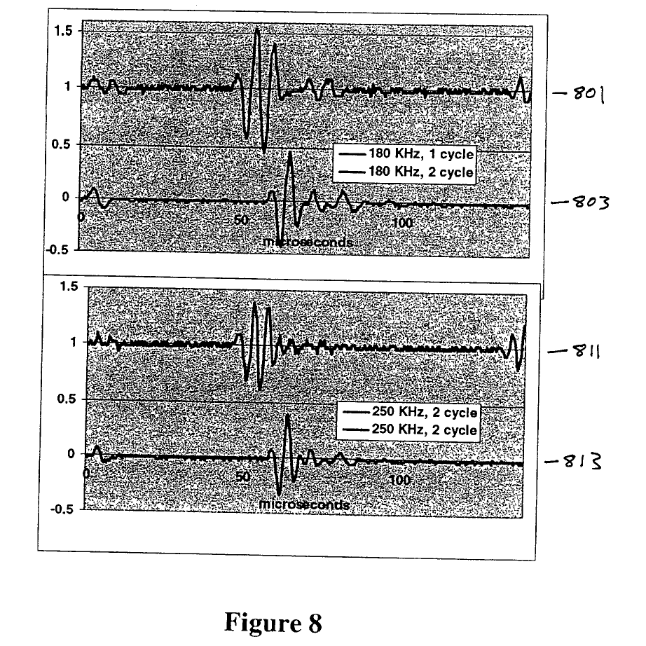

The methodology presented herein is a controlled shape input pulse. The duration and frequency content of the emitted (and thus of the received) pulse can be more easily manipulated. Consider the simple example of a high voltage sine wave input. Both the frequency and the duration can be selected to give the emitted pulse the desired center frequency and bandwidth. FIG. 8 displays the pulse response for a 250 kHz broadband transducer excited with 1-cycle 180 kHz 801, 2-cycle 180 kHz 803, 1-cycle 250 kHz 811, and 2-cycle 250 kHz 813, sine wave inputs. As can clearly be observed, the frequency content and character is highly dependent on the input signal, even at 180 kHz. Such control can be very useful as the pulse shape can be optimized for certain drilling conditions.

For instance, the transducers can be used to automatically select the optimal operating frequency down hole while drilling. As the distance between the transducer and borehole wall increases, the excitation frequency for the transducers can be lowered for lower attenuation. As the distance between the transducer and the borehole wall decreases, the transducers can be excited at higher frequency to increase resolution and prevent overlap of the reflected signal with the exciting signal, and thereby to reduce the dynamic of the transducer.

The preferred detection method of the present invention herein is wavelet analysis. Wavelet analysis has applications in the medical, seismic, and vibration fields in which known low-level responses may exist. In borehole ultrasonics, the size of the echo may be the same as the size of other signals, such as residual transducer ringing after firing, electronic noise, etc. The proper wavelet is selected to match the expected echo signature. Wavelet selection comprises consideration for both shape and duration of the wavelet, easily predictable given the results in FIG. 8. Said proper wavelet is then correlated with the entire transducer spectrum after firing. The wavelet enhances the echo above the non-wavelet like background, making detection more clear. Such technique greatly improves the dynamic range of detection for ultrasonic pulse-echo measurement in the drilling environment.

While the foregoing disclosure is directed to the preferred embodiments of the invention, various modifications will be apparent to those skilled in the art. It is intended that all such variations within the scope and spirit of the appended claims be embraced by the foregoing disclosure.

What is claimed is:

1. A logging tool conveyed in a borehole in an earth formation for determining a parameter of interest, the borehole having a fluid therein, the logging tool comprising:
(a) an acoustic transmitter for generating acoustic waves in said fluid;
(b) a first acoustic receiver and a second acoustic receiver for detecting acoustic waves propagated through said fluid over a first path length and a second path length different from said first path length; and
(c) a processor for determining from first and second travel times for acoustic waves over said first and second acoustic path length the parameter of interest.

2. The logging tool of claim 1 wherein said parameter of interest is at least one of:
(i) a velocity of acoustic waves in said fluid, and, (ii) a standoff of said logging tool from a wall of said borehole.

3. The logging tool of claim 1 wherein said acoustic transmitter further comprises a first transmitter and a second transmitter.

4. The logging tool of claim 3 wherein one of said first and second acoustic transmitters is set in a recess on said logging tool and wherein said first and second path lengths have a difference substantially equal to a depth of said recess.

5. The logging tool of claim 1 wherein said first and second acoustic receivers are spaced apart in a longitudinal direction of said logging tool.

6. The logging tool of claim 5 wherein one of said first and second acoustic receivers are set in a recess on said logging tool.

7. The logging tool of claim 1, wherein said acoustic transmitter and one of (i) the first receiver, and (ii) the second receiver, comprise a single transducer.

8. The logging tool of claim 1 wherein said processor controls an activation time of said acoustic transmitter.

9. The logging tool of claim 1 further comprising an orientation sensor for obtaining a measurement indicative of a toolface angle of said logging tool.

10. The logging tool of claim 9 wherein said orientation sensors further comprises a magnetometer.

11. The logging tool of claim 7 wherein said single transducer further comprises:
(i) a piezoelectric crystal, and
(ii) a backing for attenuating acoustic waves generated by said piezoelectric crystal in a selected direction.

12. The logging tool of claim 11 wherein said backing comprises a tungsten-polymer mixture.

13. The logging tool of claim 11 wherein said piezoelectric crystal has a concave surface, the logging tool further comprising a facing material disposed between said concave surface and said fluid in the borehole.

14. The logging tool of claim 13, wherein said facing material has an acoustical impedance between that of said piezoelectric crystal and mud.

15. A logging tool conveyed in a borehole in an earth formation for determining a parameter of interest, the borehole having a fluid therein, the logging tool comprising:
(a) an acoustic transmitter for generating acoustic waves in said fluid;
(b) an acoustic receiver for detecting acoustic waves propagated through said fluid over a specified path length; and
(c) a processor for determining from a travel time for said acoustic waves over said specified path length the parameter of interest.

16. The apparatus of claim 15 wherein said acoustic transmitter and said acoustic receiver are set in a recess on said logging tool.

17. The apparatus of claim 16 wherein said transmitter and said receiver comprise a single transducer.

18. A method of determining a parameter of interest of a fluid within a borehole, using a logging tool conveyed within said borehole, said method comprising:
a) using a transmitter on the logging tool for generating at least one acoustical pulse;
b) using a first receiver on the logging tool for obtaining a first measurement of at least one physical quantity of said at least one acoustical pulse upon propagation through said fluid having a first path length;
c) using a second receiver on the logging tool for obtaining a second measurement of said at least one physical quantity of said at least one acoustical pulse upon propagation through said fluid having a second path length; and
d) using a processor for determining said parameter of interest from a difference in said first and second measurements of said at least one physical quantity.

19. The method of claim 18, wherein the parameter of interest is at least one of (i) a velocity of acoustic waves in said fluid, and (ii) a standoff of said logging tool from a wall of said borehole.

20. The method of claim 18, wherein said at least one physical quantity comprises at least one of (i) echo time, and (ii) signal attenuation.

21. The method of claim 18, wherein said first and second paths further comprises a reflection from a surface of the borehole wall.

22. The method of claim 18, wherein said at least one acoustical pulse further comprises two acoustical pulses.

23. The method of claim 18, wherein one of the first and second receivers is set in a recess on the logging tool.

24. The method of claim 18, wherein said first and second receivers are axially spaced apart on the logging tool.

25. The method of claim 24, further comprising rotating said tool through a toolface angle.

26. The method of claim 18, wherein generating said at least one acoustical pulse further comprises generating a single acoustical pulse.

27. The method of claim 18, further comprising using a single transducer for the transmitter and one of (i) the first receiver, and, (ii) the second receiver

28. A method of determining a parameter of interest of a fluid within a borehole, using a logging tool conveyed within said borehole, said method comprising:
a) using a transmitter on the logging tool for generating an acoustical pulse;
b) using a receiver on the logging tool for measuring at least one physical quantity of said acoustical pulse after said acoustic pulse has traveled a specified distance; and
c) determining said parameter of interest from measurements from part b) and said specified distance.

29. The method of claim 28, wherein the parameter of interest is at least one of (i) a velocity of acoustic waves in said fluid, and (ii) a standoff of said logging tool from a wall of said borehole.

30. The method of claim 28, wherein said transmitter and said receiver are disposed on two parallel walls of a channel along the outer surface of said measurement tool, said parallel walls having said specified distance therebetween.

31. The method of claim 30, wherein said transmitter and said receiver form a single transducer.

32. The method of claim 28, wherein said at least one physical quantity further comprising one of at least (i) echo time, and (ii) attenuation of signal due to propagation over said specified path length.

33. A method of exciting and detecting a high-resolution pulse within a borehole environment, the borehole having a fluid therein, comprising:
a) generating said pulse at an optimal frequency; and
b) detecting signal according to an expected echo signature.

34. The method of claim 33, wherein said optimal frequency is determinable according to a distance between a transducer and the borehole wall.

35. The method of claim 34, wherein detecting said signal further comprises using wavelet analysis.

36. The method of claim 35, wherein said wavelet analysis further comprises selecting the shape and duration to match an expected echo signature.

37. An apparatus for generating and detecting an acoustical pulse propagated through a fluid, the apparatus comprising:
a) a piezoelectric crystal;
b) a backing material disposed along the back of said crystal having an impedance substantially matched to that of said crystal; and
c) a facing material disposed along the front face of said crystal having an impedance intermediate to the impedance of said piezoelectric crystal and said fluid.

38. The apparatus of claim 37, wherein said backing material is composed of a tungsten-polymer mixture.

39. The apparatus of claim 37, wherein said facing material is composed of Torlon.

40. The apparatus of claim 37, wherein the front face of said piezoelectric crystal is concave.
